(19) United States
(12) Patent Application Publication
(10) Pub. No.: US 2004/0246235 A1
(43) Pub. Date: Dec. 9, 2004

(54) Kit for updating a digital data processing system

(76) Inventor: Eric Aubry, Luxembourg (LU)

Correspondence Address: Thomas S. Baker, Jr., 1371 West 3rd Avenue, Columbus, OH, 43212, US

(21) Appl. No.: 10/884,209

(22) Filed: Jul. 2, 2004

Related U.S. Application Data
(63) Continuation-in-part of application No. 09/412,727, filed on Oct. 5, 1999.

(30) Foreign Application Priority Data
Dec. 30, 1998 (LU) 90335

(51) Int. Cl. G09G 5/00

(52) U.S. Cl. 345/168

(57) ABSTRACT

The present invention involves a kit to update a digital data processing system, such as a computer or PC, so that it can make direct use of the keyboard in integrating a non-existent supplementary symbol such as, for example, the Euro symbol. It comprises a software medium on which is recorded the update software for using a supplementary symbol on a keyboard, and an interchangeable key that additionally bears the representation of the supplementary symbol.

### CROSS-REFERENCES

This application is a continuation in part of pending application U.S. Ser. No. 09/412,727 filed Oct. 5, 1999.

### BACKGROUND OF THE INVENTION

The present invention relates to a kit for updating a digital data processing system such that a computer or PC can make direct use of the keyboard to integrate a non-existent supplementary symbol such as, for example, the Euro currency symbol.

The use of the Euro went into effect at the beginning of 1999. At present, however, the currency unit, which is represented by a symbol (just as the dollar or pound), does not exist on computer systems. Whether used for typing, accounting, trade, or correspondence, the only method of transcribing this symbol is to write it manually or incorporate a complex representation.

Consequently and in order to universalize its decoding, the inventor looked into the problem of implementing a universal solution and for the first time properly adapting financial management software written under MS-DOS and in language C (among others).

After several attempts it was found that the only decodable letters are those included in the standardized ISO table which is among others distributed on two levels, the primary level and a complement having printing restrictions.

One way to solve the problem consists of integrating the Euro symbol into the table. But it is established that all positions are occupied and that this update is not possible. Parallelly there are analyzed solution on updates for decoding fonts, but the problem fully remains because the decoding only operates in the Windows environment of Microsoft and a machine which has not been updated working on a document generated on an updated machine cannot read a decoded font. Moreover, and still more serious, a document or application run in a language or an application program not using fonts cannot be edited even on an updated machine.

Clearly, the Euro symbol generated by means of fonts will not be read or will then edit a different symbol (e.g., of the black square type) in a language not dedicated to windows.

The problem is proven, supported and extended to all types of symbols or letters which are not included in to ISO table.

It was then decided to place a solution at a higher level, that is, a decoding level independent from the operating system. To do this, attention was turned to the operating level of BIOS. It is only at this level that independence can be brought and a universal update can be used.

The invention provides a means for a very simple modification, which, once made, will modify or extend the computer system to make the aforementioned supplementary function resident, and notably simplify the ability to update all existing machines at a given moment as, for example, the implementation of the Euro.

According to the invention, this objective will be realized by means of a software medium on which is recorded the updating software that will enable use of the supplementary symbol through a key, and an interchangeable key that will additionally bear the representation of the supplementary symbol.

### BRIEF DESCRIPTION OF THE DRAWINGS

FIG. 1 is a flowchart illustrating a schematic representation of the invention; and

FIG. 2 is an ISO table.

### DESCRIPTION

It must be principally taken into account that the instant invention deploys independently of the operating system. To respond to the essential feature of decoding outside of utilization of fonts, the update is brought back to the system level BIOS (master software associated with a microprocessor and loaded on the motherboard). Thus, the only physical support is the memory installed on the motherboard.

The inventor has alternate solutions to be used differently in case of updating a machine in service or in producing a new generation. Indeed, the update may be software for modifying the system BIOS or for example for installing the function on a chip of the motherboard.

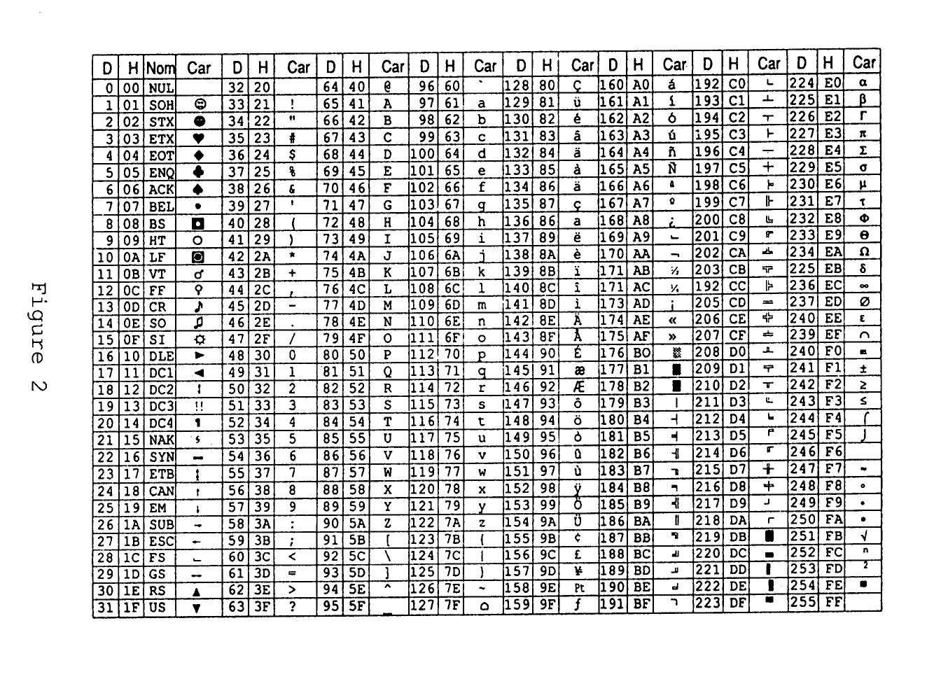

The modifying function permits adding the decoding into the table of printable letters in addition to the letters included in the ISO table, see FIG. 2. Indeed, this table of 256 positions is completely filled and other letters cannot be added.

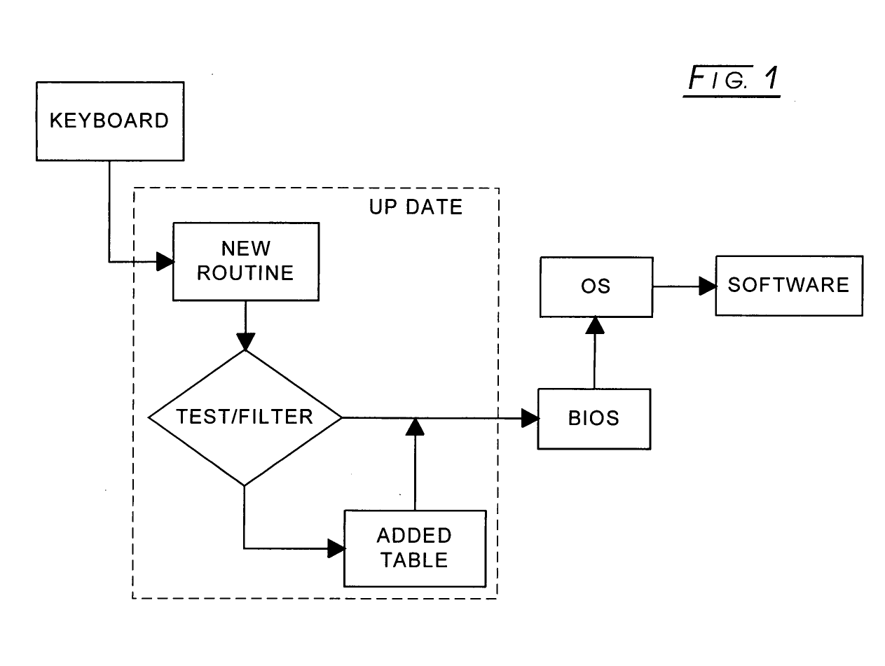

Under these conditions, a mini table added to BIOS allows the integration of new decodable letters in the primary operating level of the computer or of any other numerical resolution system. See FIG. 1.

The functions at the operating interface level may be accessed by means of a keyboard.

Where it is desired to utilize a symbol of the Euro currency, the table added and resolved in the BIOS comprises the Euro symbol letter. Making the symbol decodable and printable in BIOS makes the invention applicable to any operating system and allows the new symbol to be printed on multiple machines and in all software environments.

Through the addition of a software module to the digital data processing system software or as an add-on to the operating system, along with the replacement of a physical key on the keyboard, all devices will then be provided with a function enabling them, through a simple keystroke, to print the supplementary symbol such as, for example, the Euro. The modification occurs only once and becomes resident within the machine.

Keyboards for digital systems are provided with keys that have multiple functions. Pressing a key prints a number or symbol; a combination of keys (for example, Caps+key or Alt+key, etc.) can be variously interpreted.

Computer keyboards have one to four functions per key. When we wish to reproduce a supplementary symbol as, for example, the Euro, we dedicate an unassigned key (for example, key “1” or key “\hat{ }”) to the supplementary symbol. The Euro character is then situated on the assigned key. The operator can be presented with several possible choices when the computer system is updated.

The update procedure takes place as follows:

From the panel of choices offered, the operator selects the position assigned to the Euro symbol, or any other supplementary symbol to be reproduced by the system. The operator inserts the software medium, which can be a floppy diskette, CD-ROM, file transfer, or other, and launches the software updating routine. The operator mechanically removes the assigned key and replaces it with the new one of the same format, which incorporates, in addition to the symbols for the assigned key, an engraving or other representation of the Euro symbol. The operator then reboots the computer system and the new key function is available and resident.

The invention can be sold in the form of a kit consisting of the software medium for updating the software of a computer system and a plastic, or other, molded key that has been engraved with the supplementary symbol for updating the system's hardware level. This kit can be distributed as a separate assembly.

The software stored on the software medium operates as follows:

It comprises a universal keyboard driver or one that can be configured for the brand of hardware updated. The driver interprets the new function. It is suggested that the symbol be used the way ASCII codes are used, without however being limited to such use. An available character label (for example, CHR (32) or extension that can be added to the current table) will be used. In this way, not only the keyboard but also the software applications will be able to make direct use of the Euro character in the form of a symbol.

What is implemented in the solution of the subject invention may be described in two parts. For the microanalyses we retain:

1. The function of calling the new letter,

2. The function of the integrated decoding.

The first function is the addition of a new software module which will intercept the scan code functions by the keyboard. The write interrupt function in case of identification of the declared scan codes will be part of the update of the BIOS ROM. The decoding not directly interpretable in the ASCII table is made by means of the complementary table also added to the system which allows them to determine the printing format of the letter. See flowchart on FIG. 1.

The new interrupt function of the BIOS ROM scans and filters all the keyboard entries and calls up the decoding module be means of the complementary table only in case of need. FIG. 1 is a schematic representation of the invention.

It may be seen that, independently of the operating system OS or the applications programs, a machine which has been updated in the BIOS may interpret without fault the new letter.

The invention can be used for, without being restricted to, applications for updating existing hardware, whether or not they are in use, as well as new machines that have yet to be produced. The invention can be made available for all operating systems and all brands of hardware, as well as all types of keyboards used for digital systems.

I claim as my invention:

1: Process for updating a numerical system for data processing in a computer having a keyboard, a motherboard and a memory installed thereon, said memory at the BIOS level of the computer having an ISO table loaded therein, for integrating for use a non-existing supplementary symbol, said process characterized by selecting a keyboard key to which the supplementary symbol is assigned, updating the system by adding into the memory at the BIOS level of the computer a table having the supplementary symbol resolved therein, whereby the system is updated one single time for rendering resident the supplementary symbol in the system to make the supplementary symbol available for direct use by the operating system OS and the softwares.

2: Kit for updating a numerical system for data processing in a computer, said computer having a keyboard, a motherboard and a memory installed thereon, said memory at the BIOS level of the computer having an ISO table loaded therein, for integration for use of a non-existing supplementary symbol, said kit comprising software medium means having a software for updating a numerical system for processing data recorded thereon, said software enabling updating the system by adding into the memory at the BIOS level of the computer a table having the supplementary symbol resolved therein, whereby the system is updated one single time for rendering resident the supplementary symbol in the system to make the supplementary symbol available for direct use by the operating system OS and the softwares.

3: Kit for updating a numerical system for data processing in a computer of claim 2, further comprising a keyboard key for exchange bearing in addition the representation of the supplementary symbol in the system to make the supplementary symbol available for direct use by the operating system OS and the softwares.
